(19) United States
(12) Patent Application Publication
(10) Pub. No.: US 2007/0232337 A1
(43) Pub. Date: Oct. 4, 2007

(54) Method for transmitting a short message on a voice channel

(75) Inventor: Seaman Hai Yang Yu, Qingdao (CN)

Correspondence Address: HARNESS, DICKEY & PIERCE, P.L.C., P.O. BOX 8910, RESTON, VA, 20195, US

(73) Assignee: Lucent Technologies Inc.

(21) Appl. No.: 11/645,604

(22) Filed: Dec. 27, 2006

(30) Foreign Application Priority Data
Mar. 28, 2006 (CN) 200610071139.0

(51) Int. Cl. H04Q 7/20

(52) U.S. Cl. 455/466

(57) ABSTRACT

An example embodiment of the present invention may be directed to a method for transmitting a short message using a voice channel. In the example embodiment, a short message may be composed using a first short message service (SMS) device for a set of intended recipients. The first SMS device may identify whether a voice channel exists between the first SMS device and at least one member of the set of intended recipients. The first SMS may then transmit the short message to the at least one member of the set of intended recipients using the voice channel.

### DESCRIPTION OF THE RELATED ART

The invention relates generally to wireless communication systems and, more particularly, to methods used for transmitting short messages in the presence of an active voice channel.

### BACKGROUND OF THE INVENTION

The paradigm of communications services surrounding Short Message Service (SMS) permits the sending of short messages (also known as text messages, messages, SMSes, texts or txts) between cellular phones, hand held devices and internet connected computer systems. The modern day SMS has gone beyond the use of simply text messaging to include the ability to transact commerce, such as for example, purchasing ring tones, receiving news alerts and accessing financial information.

The market for SMS has been growing exponentially, logging approximately 500 billion messages per annum in 2004. In many markets, the service is comparatively cheap, wherein a large number of messages are included in a calling plan, or wherein the average cost of a text message costs 10-20% the cost of a comparative voice call. At a typical length of only 190 bytes, more than 350 of these messages per minute can be transmitted at the same data rate as a usual voice call (9 kbps).

Short messages are sent to a short message service center (SMSC), which uses a store-and-forward mechanism to deliver the short messages to a recipient. The store-and-forward mechanism functions on a “best-effort” basis, as there is no guarantee that a sent message will be delivered to its intended recipient. The SMSC will continue making attempts to forward the short message until the recipient is reached, or a maximum time limit has elapsed. Therefore, delay or complete loss of a message is not uncommon, particularly when sending messages between different telephone networks. Some networks allow users to request delivery receipts, which can provide a positive indication that a message was delivered. However, these are also on a best effort basis and thus unreliable.

Transmission of the short messages between an SMSC and an SMS client is limited to a 140-byte payload, due to the constraints of the signaling protocol. In practice, this translates to either 160 7-bit characters, 140 8-bit characters, or 70 2-byte Unicode characters (UTF-16 character encoding) for languages such as Arabic, Chinese, Korean, Japanese or the Slavonic languages. Furthermore, routing data and other metadata may further limit the available payload. Larger content can be sent across multiple associated messages. Upon successful transmission, all the associated messages are concatenated. However, the size of a user data header (UDH) containing segmentation information further limits the data. While the standard theoretically permits up to 255 segments to a segmented message, 3 to 4 segment messages are the practical maximum, and long messages are billed as equivalent to multiple short messages.

FIGS. 1 and 2 illustrate prior art methods for transmitting short messages between two mobiles, in accordance with the prior art. Shaded arrows are used to designate messages traveling to the SMSC, while white arrows designate messages traveling to the intended recipient.

FIG. 1 illustrates an SMS transmission between two distantly located mobiles, that are registered with different base stations (BS) and mobile switching centers (MSC), in accordance with the prior art.

In FIG. 1, a first mobile 11 is located in a cell served by a BS 15. BS 15 is connected via the cellular network to a MSC 19, which is in contact with a centralized SMSC 23. A second mobile 13 is located in a cell served by a BS 17. BS 17 is connected via the cellular network to a MSC 21, which is in contact with the centralized SMSC 23.

The first mobile 11 intends to transmit a short message to the second mobile 13. After composing the short message, the first mobile 11 transmits the short message on a control channel to the BS 15, which forwards the short message to MSC 19. MSC 19 transmits the short message to the centralized SMSC 23. The SMSC 23 determines the availability of the intended recipient, second mobile 13. If the second mobile 13 is available, the SMSC 23 will forward the message to MSC 21, which transmits the SMS to the second mobile 13 via BS 17.

FIG. 2 illustrates an SMS transmission between two closely located mobiles, that are registered with the same base station and mobile switching center, in accordance with the prior art.

In FIG. 2, the first mobile 111 is located in a cell served by BS 15. BS 21 connects via the cellular network to MSC 19, which is in contact with centralized SMSC 23. The second mobile 13 is also located in the cell served by BS 17.

The first mobile 11 intends to transmit a short message to the second mobile 13. After composing a short message, the first mobile 11 transmits the short message on the control channel to MSC 19, via BS 15. The MSC 19 transmits the short message to the centralized SMSC 23. The SMSC then determines the availability of the intended recipient, second mobile 13. If the second mobile 13 is available, the SMSC 23 forwards the message to MSC 19, which transmits the short message to the second mobile 13 via BS 17.

While FIGS. 1 and 2 offer simplified models of SMS transmission paths, it can be understood that depending on the mobile stations' cellular providers and locations, other SMS transmission paths may result (e.g. some paths may employ multiple SMSCs). However, regardless of the resulting SMS transmission path, the prior art requires that the short message travel through a minimum of one SMSC.

Text Messages offer a number of benefits over voice communications. Upon receipt, the sender's intended message is guaranteed to be accurate. Where voice messages may lose quality and fidelity, text messages will normally transfer correctly or not at all. Second, text messages can be stored and later retrieved. Third, Text messages can include multimedia content (e.g. such as audio or video).

### SUMMARY OF THE INVENTION

A trend in wireless communication is to carry voice communication in the form of data packets over a wireless communication channel. When two cell phone users carrying on a conversation desire to transmit some information between them using text messages, it may be beneficial to use the active voice data packet channel, instead of using the conventional SMS routing path. Such a technique offers a number of benefits to the existing SMS infrastructure. First, given the exponential growth experienced by the existing SMS system, there is a benefit to reducing the existing traffic when a pre-existing connection exists between the sender and recipient by employing a shorter communications path (e.g. the voice data packet channel). Second, users receive the enhanced security of having the message route directly between them and not through the centralized SMSC. Third, users can send information to other parties without the risk of error and without having to reenter the numbers of the other parties. Further benefits exist but are not enumerated, for brevity.

An example embodiment of the present invention may be directed to a method for transmitting a short message using a voice channel. In the example embodiment, a short message may be composed for a set of intended recipients, using a first short message service (SMS) device. The first SMS device may identify whether a voice channel exists between the first SMS device and at least one member of the set of intended recipients. The first SMS device may then transmit the short message to the at least one member of the set of intended recipients using the voice channel.

In a related example embodiment, transmitting the short message may include forming the short message into one or more short message data packets, placing the short message data packets in a queue containing voice data packets, and the sending data packets in the queue to the set of intended recipients.

Another example embodiment of the present invention may be directed to a method for receiving a short message over a voice channel. In this example embodiment, an SMS device may identify incoming data on the voice channel as short message data, and separate the short message data on the voice channel from voice data.

Yet another example embodiment of the present invention may be directed to a method for routing a short message from a first SMS device to at least one intended second SMS device on a voice channel. In this example embodiment, a base station receives a short message on a voice channel from a first SMS device, the short message being intended for the at least one intended second SMS device. The base station may then route the short message directly to the at least one intended second SMS device.

### BRIEF DESCRIPTION OF THE DRAWINGS

The present invention will become more fully understood from the detailed description given herein below and the accompanying figures. In the figures, like elements are represented by like reference numerals, which are given by way of illustration only and thus do not limit the present invention.

FIG. 1 illustrates an SMS transmission between two distantly located mobiles that are registered with different base stations (BS) and mobile switching centers (MSC), in accordance with the prior art.

FIG. 2 illustrates an SMS transmission between two closely located mobiles that are registered with the same base station and mobile switching center, in accordance with the prior art.

FIG. 3 illustrates an SMS transmission between two distantly located mobiles that are registered with different base stations and mobile switching centers, in accordance with an example embodiment of the present invention.

FIG. 4 illustrates an SMS transmission between two closely located mobiles that are registered with the same base station and mobile switching center, in accordance with an example embodiment of the present invention.

FIG. 5 illustrates a method for transmitting a short message between two mobiles in accordance with an example embodiment of the present invention.

FIG. 6 illustrates an example embodiment of the mobile devices used to perform the method illustrated in FIG. 5.

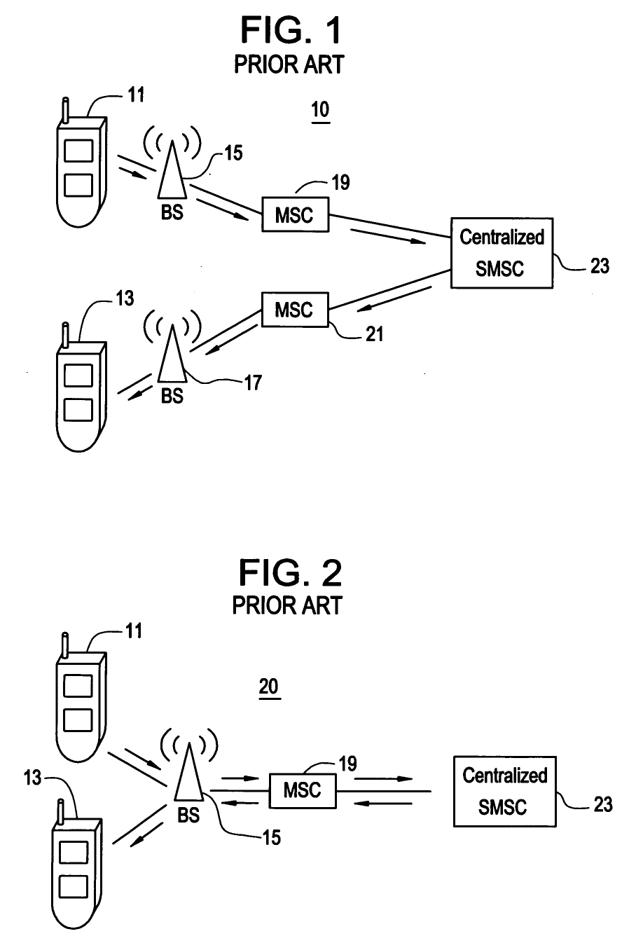

### DETAILED DESCRIPTION OF THE EMBODIMENTS

An example embodiment of the present invention is directed to a method of transmitting SMS on a voice data packet channel of an existing voice conversation taking place between two SMS capable devices, such as two mobiles. During a conversation, each SMS device is allocated two voice data packet channels, a voice transmission channel and a voice receiving channel for voice packet communications. The example embodiment may transmit short messages between two SMS devices by transmitting the SMS data on the voice transmission channel and receiving SMS data on the voice receiving channel, along with the voice data.

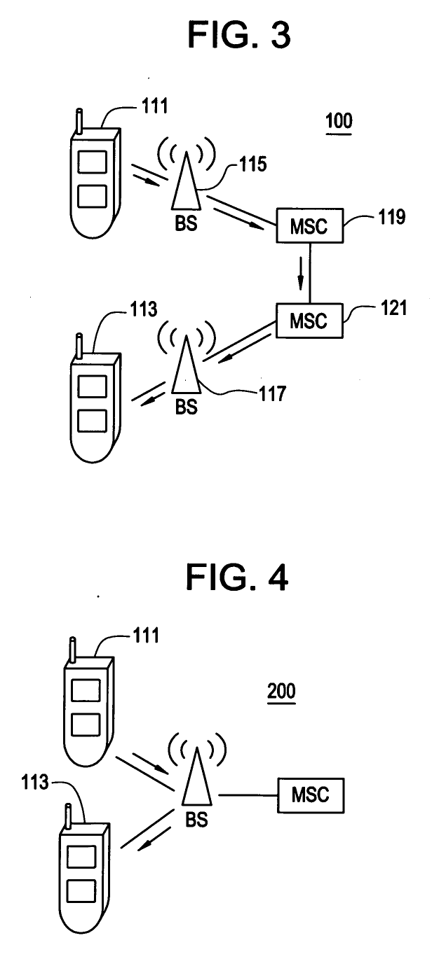

FIG. 3 illustrates the transmission path of the SMS transmission between two distantly located mobiles that are registered with different base stations and mobile switching centers, in accordance with an example embodiment of the present invention.

Active voice data packet communications generally travel a shorter route between two mobile devices than short messages. By using the voice channel, the short messages can avoid passing through a number of intermediate hops. In FIG. 3, a short message uses the voice data packet channel to travel between a first mobile 111 and a second mobile 113. The voice channel between the first mobile 111 and the second mobile 113 passes through BS 115, MSC 119, MSC 121, and BS 117. Therefore, the example embodiment avoids passing a short message through an SMSC and therefore requires 2 fewer hops.

FIG. 4 illustrates the transmission path of the SMS transmission between two mobiles in nearby locations, associated with the same base station, and registered with the same mobile switching center, in accordance with an example embodiment of the present invention.

In FIG. 4, a short message uses the voice data packet channel to travel between the first mobile 111 and the second mobile 113. The voice channel between the first mobile 111 and the second mobile 113 passes through only the BS 115. The benefits of using the voice data packet channel to transmit the short message are more apparent than in FIG. 3. By using the voice channel, the short messages can avoid passing through 4 hops (see FIG. 2), and reduces the path between the mobiles by over sixty percent because the voice channel between the first mobile 111 and the second mobile 113 passes only through BS 115. It can be understood that the benefit derived from the example embodiment is based on the layout of the network and path between the two mobiles, 111 and 113.

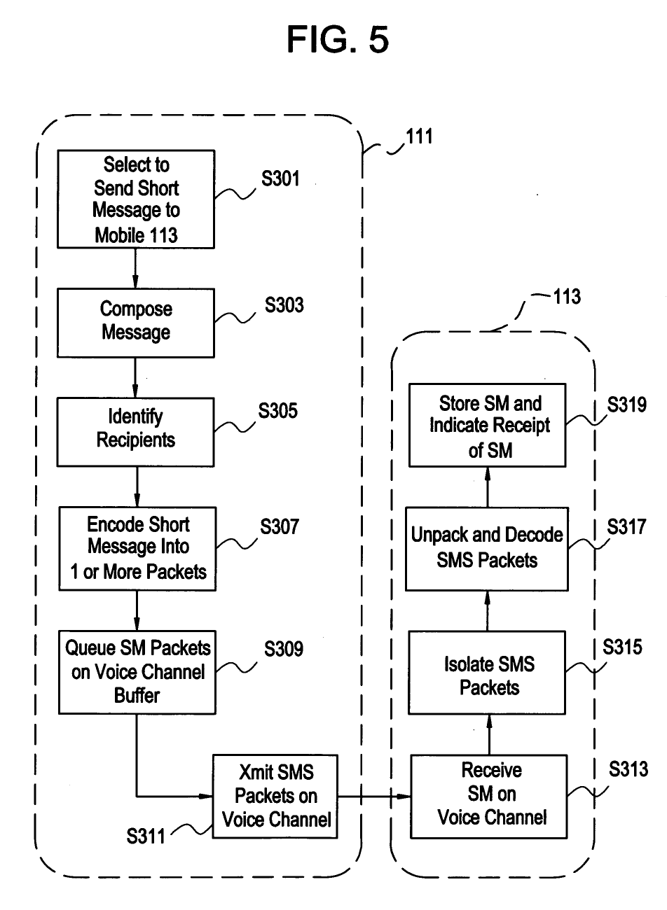

FIG. 5 illustrates a method for transmitting an SMS in accordance with the example embodiment of the present invention. In FIG. 5, the mobile devices are actively engaged in a voice-call conversation. Therefore, the cellular system has already assigned a pair of voice data packet channels to each mobile. Having established the voice-call setup procedures, the cellular system has also already established the routing path for the voice data associated with the ongoing conversation.

In FIG. 5, the first mobile 111 performs the sending steps (S301-S311), while the second mobile 113 performs the receiving steps (S313-S319).

In step S301, the mobile user of the first mobile 111 navigates the menus of the mobile to begin composing an outgoing message.

In step S303, the user of the first mobile 111 may compose the message. In one example embodiment, the first mobile user may need to select to whom the short message may be sent. In another related embodiment, the mobile may select the recipients based on any established voice channels. For example, the first mobile may have a voice channel established with a group of SMS capable devices, such as when conducting a conference call. In such a case, the mobile may send the message to all or a portion of the SMS devices engaged in the conference call. In yet another related embodiment, the first mobile user may be able to select a group of intended recipients comprised of a group of SMS capable devices, a portion of which the first mobile may have established a voice channels, and another portion of which do not have an established a voice channel with the first mobile. In yet another related embodiment, the mobile may select a group consisting only of SMS capable devices which the first mobile does not have an established a voice channel, whereby the mobile establishes a voice channel before sending the short message.

In step S307, the first mobile 111 encodes the short message in one or more SMS data packets. As will be understood, both the SMS data packets and the voice data packets generally include a header. The header includes, among other things, routing information for routing the data packet to its destination and an identifier. The identifier identifies the type of data packet; for example, identifies whether the data packet is a voice data packet or a SMS data packet.

Returning to Step S307, if the short message is longer than a size constraint, the short message may be encoded into a series of sequential short messages limited by a size constraint, before being encoded. In another embodiment, if the short message is longer than a size constraint, the entire message may first be encoded and then divided into one or more SMS data packets.

Next, in step S309, the first mobile 111 queues the SMS packets using a buffer reserved for the outgoing voice channel. In step S311, the packets in the transmission buffer are then transmitted using the voice channel, in accordance with the existing methods known in the art.

The SMS receiving steps in accordance with the example embodiment begin, at the second mobile 113, with step S313, where the SMS packets are received on the voice channel. The received SMS packets are then identified based on the identifier in their header, and are separated from the voice packet data, in step S315. Next, the SMS packets are then combined and decoded to recreate the short message composed by the user of the first mobile 111. In step S319, the receiving mobile 113 may store the short message and indicate that the SMS was received 521.

The second mobile 113 may store the short message in the same storage used for storing short messages received in accordance with the prior art. Alternatively, the short message may be stored in a separate area of the memory, not associated with short messages received in accordance with the prior art.

The second mobile 113 may also indicate that a short message was received similarly as when indicating that a short message was received in accordance with the prior art. Alternatively, the second mobile may reserve a unique indicator (e.g., audio and/or visual indicator) for alerting that a short message was received on the voice channel.

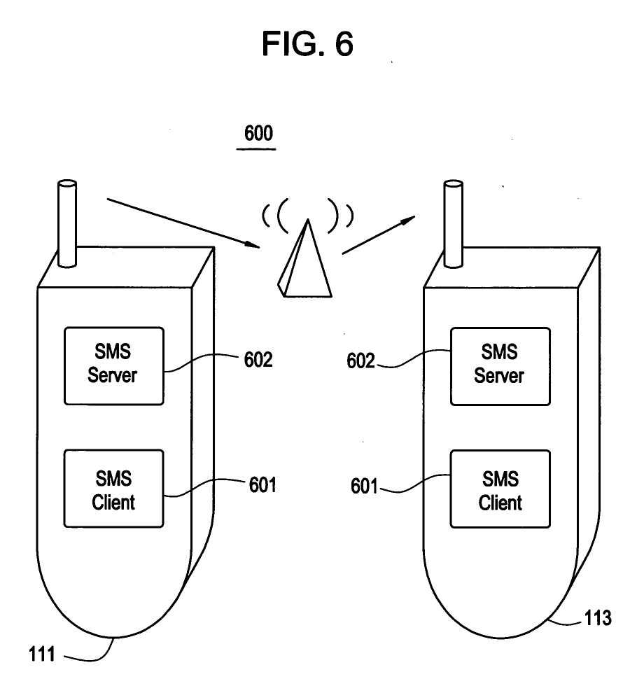

FIG. 6 illustrates an example embodiment of the mobile devices used to perform the method illustrated in FIG. 5.

To accomplish the aforementioned steps of FIG. 5, each mobile may contain both a mobile SMS client component 601 and a mobile SMS server component 602. The transmission steps (S301-S311) or any portion thereof may be performed by the SMS client 601, while the receiving step (S313-S319) or any portion thereof may be performed by the SMS server 602. The mobile SMS client component 601 and a mobile SMS server component 602 may provide some of the functionality otherwise provided in the SMSC.

The embodiments of the present invention provide for methods for transmitting short messages in the presence of an active audio communication. Using the voice channel may reduce load and improve the efficiency of SMS transmissions.

The invention being thus described, it will be obvious that the same may be varied in many ways. For example, while described for a voice channel, it will be appreciated that all or a portion of the embodiments may be applied to any active channel linking multiple SMS devices. As another example, while described with SMS capable devices, the present invention may be applicable to other types of messaging systems. Such variations are not to be regarded as a departure from the invention, and all such modifications are intended to be included within the scope of the invention

We claim:

1. A method for transmitting a short message using a voice channel, comprising:
composing a short message on a first short message service (SMS) device for a set of intended recipients;
identifying that a voice channel exists between the first SMS device and at least one member of the set of intended recipients;
transmitting the short message to the at least one member of the set of intended recipients using the voice channel.

2. The method of claim 1, wherein the transmitting step transmits at least one data packet of short message data using the voice channel.

3. The method of claim 1, wherein the voice channel is a data packet channel.

4. The method of claim 3, wherein the transmitting step transmits a plurality of voice data packets and at least one short message data packet.

5. The method of claim 4, wherein each of the data packets includes an identifier to identify the packet as being at least one of a voice data packet and a short message data packet.

6. The method of claim 1, wherein the transmitting step comprises:
forming the short message into one or more short message data packets;
placing the short message data packets in a queue containing voice data packets; and
sending data packets in the queue to the set of intended recipients.

7. The method of claim 1, wherein the set of intended recipients includes a single destination device.

8. The method of claim 1, wherein the set of intended recipients includes a plurality of destination devices.

9. The method of claim 1, wherein the set of intended recipients is designated by a user of the first SMS device.

10. The method of claim 1, further comprising:
establishing a voice channel with at least one recipient in the set of intended recipients after a user of the first SMS device composes the short message.

11. The method of claim 1, further comprising:
establishing a voice channel with at least one recipient in the set of intended recipients before a user of the first SMS device composes the short message.

12. A method for receiving a short message over a voice channel, comprising:
identifying incoming data on the voice channel as short message data; and
separating the short message data on the voice channel from voice data.

13. The method of claim 11, wherein
the incoming data on the voice channel includes a plurality of voice data packets and at least one short message data packet;
the identifying step identifies the voice data packets from the at least one short message data packet; and
the separating step separates the at least one short message data packet from the voice data packets.

14. The method of claim 13, wherein the identifying step identifies the short message data packets based on an identifier in a header of the short message data packets.

15. The method of claim 14, further comprising:
forming a short message from the separated short message data packets.

16. The method of claim 12, further comprising:
alerting a recipient of the short message data that short message data has been received.

17. The method of claim 16, wherein the alerting step includes providing at least one of a sound and a visual indicator for identifying that a short message was received.

18. The method of claim 17, wherein the at least one sound and visual indicator is the same as an alert used upon receipt of a short message received from a short message service center.

19. A method for routing a short message from a first SMS device to at least one intended second SMS device on a voice channel, comprising:
receiving, at a base station, a short message on a voice channel from the first SMS device, the short message intended for the second SMS device;
routing, from the base station, the short message directly to the second SMS device.
